(19) United States
(12) Patent Application Publication
(10) Pub. No.: US 2024/0086265 A1
(43) Pub. Date: Mar. 14, 2024

(54) Selective aggregation of messages in collective operations

(71) Applicant: Mellanox Technologies, Ltd., Yokneam (IL)

(72) Inventor: Richard Graham, Knoxville, TN (US)

(21) Appl. No.: 18/074,563

(22) Filed: Dec. 5, 2022

Related U.S. Application Data
(60) Provisional application No. 63/405,504, filed on Sep. 12, 2022.

(51) Int. Cl. G06F 9/54

(52) U.S. Cl. CPC G06F 9/546

(57) ABSTRACT

A method for collective communications includes invoking a collective operation over a group of computing processes in which the processes in the group concurrently transmit and receive data messages to and from other processes in the group via a communication medium. The processes detect respective sizes of the data messages and transmit the data messages for which the respective sizes are greater than a predefined threshold to respective destination processes in the group without aggregation. The data messages for which the respective sizes are less than the predefined threshold are aggregated, and the aggregated data messages are transmitted to the respective destination processes.

### CROSS-REFERENCE TO RELATED APPLICATION

This application claims the benefit of U.S. Provisional Patent Application 63/405,504, filed Sep. 12, 2022, which is incorporated herein by reference.

### FIELD

The present invention relates generally to high-performance computing (HPC), and particularly to communication among collaborating software processes using collective operations.

### BACKGROUND

Collective communications are used by groups of computing nodes to exchange data in connection with a distributed processing application. In HPC, for example, the nodes are typically software processes running in parallel, for example on different computing cores. The nodes exchange collective communications with one another in connection with parallel program tasks carried out by the processes. The term “collective operation” is used in the present description and in the claims to refer to functions performed concurrently by multiple processes (and possibly all the processes) participating in a parallel processing task. These collective operations typically include communication functions, which are thus referred to as “collective communications.” The collective communications among processes may be exchanged over any suitable communication medium, such as over a physical network, for example a high-speed switch fabric or packet network, or via shared memory within a computer.

Various protocols have been developed to support collective communications. One of the best-known protocols is the Message Passing Interface (MPI), which enables processes to move data from their own address spaces to the address spaces of other processes through cooperative operations carried out by each process in a process group. In MPI parlance, the process group is referred to as a “communicator,” and each member process is identified as a “rank.” MPI collective operations include all-to-all, all-to-all-v, and all-to-all-w operations, which gather and scatter data from all ranks to all other ranks in a communicator. In the operation all-to-all, each process in the communicator sends a fixed-size message to each of the other processes. The operations all-to-all-v and all-to-all-w are similar to the operation all-to-all, but the messages may differ in size. In all-to-all-w, the messages may also contain different data types.

In naïve implementations of all-to-all-v and all-to-all-w, each member process transmits messages to all other member processes in the group. In large-scale HPC distributed applications, the group can include thousands of processes running on respective processing cores, meaning that millions of messages are exchanged following each processing stage. To reduce the communication burden associated with this message exchange, message aggregation protocols have been proposed.

For example, U.S. Pat. No. 10,521,283 describes in-node aggregation of MPI all-to-all and all-to-all-v collectives. An MPI collective operation is carried out in a fabric of network elements by transmitting MPI messages from all the initiator processes in an initiator node to designated responder processes in respective responder nodes. Respective payloads of the MPI messages are combined in a network interface device of the initiator node to form an aggregated MPI message. The aggregated MPI message is transmitted through the fabric to network interface devices of responder nodes, which disaggregate the aggregated MPI message into individual messages and distribute the individual messages to the designated responder node processes.

### SUMMARY

Embodiments of the present invention that are described hereinbelow provide improved methods for message aggregation in collective communications, as well as systems and software implementing such methods.

There is therefore provided, in accordance with an embodiment of the invention, a method for collective communications, which includes invoking a collective operation over a group of computing processes in which the processes in the group concurrently transmit and receive data messages to and from other processes in the group via a communication medium. The processes detect respective sizes of the data messages. The data messages for which the respective sizes are greater than a predefined threshold are transmitted to respective destination processes in the group without aggregation. The data messages for which the respective sizes are less than the predefined threshold are aggregated, and the aggregated data messages are transmitted to the respective destination processes.

In some embodiments, aggregating the data messages includes dividing the group into sub-groups, and aggregating the data messages within each sub-group. In one embodiment, dividing the group into sub-groups includes defining a static division of the group into the sub-groups. In an alternative embodiment, dividing the group into sub-groups includes defining the sub-groups in response to an order of arrival of the data messages from the processes in the group. In a disclosed embodiment, aggregating the data messages includes dividing each sub-group into sub-blocks according to the respective destination processes to which the data messages are destined, and aggregating the sub-blocks within each sub-group.

In some embodiments, aggregating the data messages includes performing a multi-step aggregation procedure. In some embodiments, the procedure has radix k>2, such that in at least a first step, any given process receives at least a first data buffer destined to the given process and a second data buffer destined to a destination process different from the given process, and in at least a second step, subsequent to the first step, the given process forwards the second data buffer to the destination process. Typically, in the second step, the given process aggregates data from a local buffer of the given process that is destined to the destination process together with the second data buffer, and transmits the aggregated data in a single transmission to the destination process. With the possible exception of the last step, the number of buffers sent and received at each step is k−1. Additionally or alternatively, in at least the first step, the given process transmits at least first and second local buffers respectively to first and second processes within the group, and in at least the second step, the given process transmits at least third and fourth local buffers respectively to third and fourth processes within the group, which are different from the first and second processes.

In a disclosed embodiment, invoking the collective operation includes initiating an all-to-all-v, all-to-all-w, all-gather-v, gather-v, or scatter-v operation. The specific pattern of aggregation of small messages that is described above is appropriate for all-to-all operations. Other aggregation patterns may be used for other types of collective operations.

There is also provided, in accordance with an embodiment of the invention, a system for collective communications, including multiple processors, which are interconnected by a communication medium and are programmed to run respective computing processes. Upon receiving an invocation of a collective operation over a group of the processes in which the processes are to concurrently transmit and receive data messages to and from other processes in the group via the communication medium, the processes detect respective sizes of the data messages, transmit the data messages for which the respective sizes are greater than a predefined threshold to respective destination processes in the group without aggregation, and aggregate the data messages for which the respective sizes are less than the predefined threshold and transmit the aggregated data messages to the respective destination processes.

There is additionally provided, in accordance with an embodiment of the invention, a computer software product for collective communications among a group of computing processes running on processors, which are interconnected by a communication medium. The product includes a tangible, non-transitory computer-readable medium in which program instructions are stored. The instructions cause the processors, upon receiving an invocation of a collective operation over a group of the processes in which the processes are to concurrently transmit and receive data messages to and from other processes in the group via the communication medium, to detect respective sizes of the data messages, to transmit the data messages for which the respective sizes are greater than a predefined threshold to respective destination processes in the group without aggregation, and to aggregate the data messages for which the respective sizes are less than the predefined threshold and transmit the aggregated data messages to the respective destination processes.

The present invention will be more fully understood from the following detailed description of the embodiments thereof, taken together with the drawings in which:

### BRIEF DESCRIPTION OF THE DRAWINGS

FIG. 1 is a block diagram that schematically illustrates collective communications in a computer system, in accordance with an embodiment of the invention;

FIG. 2 is a flow chart that schematically illustrates a method for collective communications, in accordance with an embodiment of the invention;

FIGS. 3, 4, 5, 6, 7, 8 and 9 are block diagrams that schematically illustrate data buffers exchanged among processes in an aggregated collective communication operation, in accordance with an embodiment of the invention; and

FIGS. 10A and 10B are block diagrams that schematically illustrate a method for partitioning and message aggregation among a group of processes carrying out a collective communication operation, in accordance with an embodiment of the invention.

### DETAILED DESCRIPTION

### Overview

Message aggregation in collective communications is advantageous particularly in transmitting small messages, since in this case the communication bandwidth demand and latency are dominated by the number of data packets that are exchanged, rather than the volume of data. On the other hand, when the messages are large, direct transmission without aggregation is generally preferred due to the additional bandwidth consumed by transmission of aggregated messages, as well as the added computational burdens of aggregation and disaggregation. In all-to-all operations, the programmer can decide in advance whether or not to use message aggregation, since all messages have the same, known size. This expedient is not available in all-to-all-v and all-to-all-w, since the message sizes vary, and each process in these sorts of message exchanges has information only about the messages that it sends or receives itself. It is therefore difficult to decide optimally whether or not to aggregate the messages in these sorts of collective operations.

Embodiments of the present invention address this problem, providing methods for data exchange that improve the efficiency of large-scale collective operations, particularly the all-to-all-v and all-to-all-w operations. The present embodiments dynamically split any given data exchange between two concurrent patterns: a direct exchange algorithm and an aggregation scheme. This split is made dynamically at each call to the collective function based on the size of the data, such that long messages are exchanged directly while short messages are aggregated to the respective destinations.

The disclosed methods are implemented upon invocation of a collective operation in which computing processes concurrently transmit and receive data messages to and from other processes in a group via a communication network. The processes detect the respective sizes of the data messages and transmit data messages having respective sizes greater than a predefined threshold to respective destination processes in the group by direct exchange, i.e., without aggregation. For data messages having respective sizes less than the predefined threshold, the processes in the group aggregate the data messages and transmit the aggregated messages to the respective destination processes.

Even for small messages, there are limits to the benefit of aggregation. When aggregation is used, messages are forwarded multiple times within the group before reaching their destination. As the group size increases, the number of times any given message is forwarded increases. Consequently, aggregation can become too expensive, so that direct exchange is more effective. To mitigate this problem, the collective group is split into subgroups, with aggregation carried out only within each of the subgroups, followed by direct exchange of the aggregated messages to the final destinations. In this manner, aggregation of small messages can continue to be used with good efficiency even as the collective group grows.

The subgroups for this purpose can be defined statically, based on rank, or dynamically, based on criteria such as order of arrival. In this latter case, the aggregation subgroups are formed ad hoc depending upon the times of arrival of the processes at the collective operation, so that aggregation is not delayed while awaiting the tardy arrival of a message from a (static) subgroup member. A technique that can be used in this context to define the dynamic subgroups based on order of arrival of the messages is described, for example, in U.S. Pat. No. 11,196,586, whose disclosure is incorporated herein by reference.

In some embodiments, the techniques described in U.S. Provisional Patent Application 63/356,923, filed Jun. 29, 2022, whose disclosure is incorporated herein by reference, may be used in transmission of large messages. This provisional patent application describes a direct exchange algorithm that uses “Send Ready” notifications to preventing blocking due to late-arriving messages. This technique may be used in embodiments of the present invention to improve the overall application performance in the presence of load imbalance.

Although the present embodiments are described specifically with reference to the all-to-all-v and all-to-all-w operations, the principles of these embodiments may similarly be applied in accelerating other collective operations in which message sizes are not known in advance, such as all-gather-v, gather-v, and scatter-v.

Furthermore, although these embodiments are framed in terms of MPI operations and protocols, the principles of the present invention may alternatively be implemented, mutatis mutandis, in conjunction with other protocols. All such alternative implementations are considered to be within the scope of the present invention.

### System Description

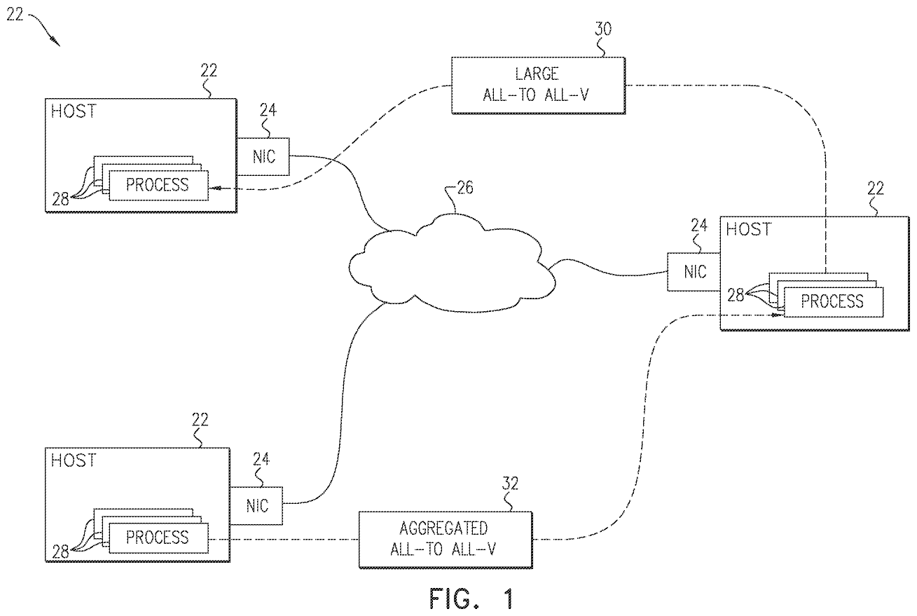

FIG. 1 is a block diagram that schematically illustrates collective communications in a computer system 20, in accordance with an embodiment of the invention. System 20 in this example comprises multiple processors, in the form of host computers 22, each comprising a central processing unit (CPU), memory, and other components as are known in the art. Each host computer 22 is connected by a respective network interface controller (NIC) 24 to a network 26, such as a high-speed switch fabric or other packet communication network. Although for the sake of simplicity only three host computers are shown in FIG. 1, in practice system 20 may comprise hundreds or thousands of host computers, interconnected by network 26. Host computers 22 in system 20 run a distributed HPC software application, in which multiple processes 28 run in parallel on different host computers. Typically (although not necessarily), each host computer 22 comprises multiple CPU cores, and each process 28 is assigned to run on a respective core.

Following certain computational stages in the distributed application, the program instructions invoke a collective operation, such as an all-to-all-v operation in the pictured example. In the context of this collective operation, system 20 defines an MPI communicator including all the participating processes 28, and each process has a respective rank within the communicator. In response to these instructions, each process 28 prepares data messages to all the other processes (ranks) within system 20. Processes 28 transmit large messages 30, greater than a certain threshold size, such as 500 bytes, directly to the destination processes. Processes 28 aggregate smaller messages that are destined to a common destination process and then pass aggregated messages 32 to the respective destination process.

Methods for message aggregation and transmission are described in detail hereinbelow. The aggregation may take advantage of capabilities of NICs 24 in supporting collective operations, for example as described in the above-mentioned U.S. patents.

Host computers 22 carry out the collective operations that are described herein, including particularly the present methods of selective aggregation, under the control of software instructions. The software for these purposes may be downloaded to the host computers in electronic form, for example over network 26. Additionally or alternatively, the software may be stored on tangible, non-transitory computer-readable media, such as optical, magnetic, or electronic memory media.

### Methods for Message Aggregation

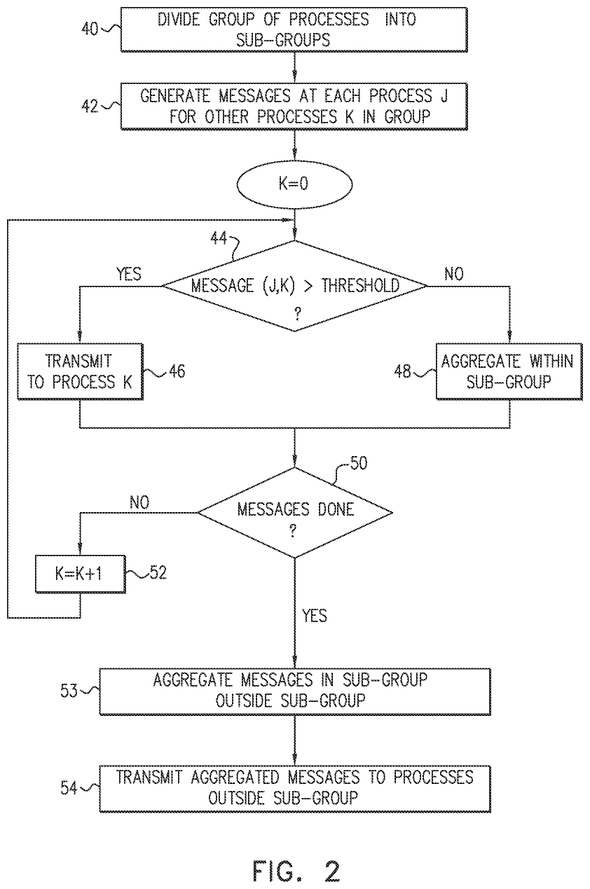

FIG. 2 is a flow chart that schematically illustrates a method for selective aggregation of collective communications, in accordance with an embodiment of the invention. This method can be used, for example, in system 20, or in any other computing system with suitable processing and communication facilities for running a distributed software application with collective communications.

Referring to FIG. 1, the method is carried out by a group of processes 28, in accordance with program instructions provided to the respective host computers 22. In some implementations of the method, aggregation of small messages is performed over the entire group of processes. In large groups, however, aggregation over the entire group may cause an impractical burden on computing and communication resources. Therefore, large groups of processes may be divided into multiple smaller sub-groups, at a grouping step 40. The sub-groups may be static, for example based on communication proximity by grouping together processes running on the same host computer 22 or on host computers within a sub-network. Alternatively, the processes may form sub-groups ad hoc, at later stages in the method, based on times of arrival of the messages, for example using techniques for detecting order of arrival that are described in the above-mentioned U.S. Pat. No. 11,196,586 (particularly col. 9, lines 39-67).

Following each processing stage in the application, processes 28 generate messages for transmission to the other processes participating in the application, at a message generation step 42. In the present example, it is assumed that the messages are to be exchanged using the all-to-all-v collective. Thus, assuming the group includes N processes, any given process J will prepare N message buffers, typically of different, respective sizes, containing data for transmission to the processes in the group (including itself) K=0, 1, . . . , N−1. Although the steps below are described sequentially for the sake of clarity, in practice these steps are typically carried out in parallel by the participating processes.

Each process J compares the sizes of each of its message buffers (J,K) in turn to a selected threshold, at a size checking step 44. The threshold is typically set by a programmer depending on the characteristics of system 20. Alternatively or additionally, the threshold may be set and adjusted automatically in response to conditions of the system and the software application. In some embodiments, the threshold is on the order of 500 bytes, but larger or smaller thresholds may alternatively be applied. If the message size to a destination process K is found to be larger than the threshold, the transmitting process J sends the message directly to process K without aggregation, at a direct transmission step 46.

On the other hand, if a message buffer (J,K) is within the threshold size for aggregation, process J includes the corresponding message in the set of messages that are to be aggregated for destination process K, at an aggregation step 48. Process J checks whether all of its N buffers have been evaluated and sorted, at a completion checking step 50. If not, the method continues to the next destination process K+1, at a next process step 52.

Once all the small messages of process J and the other processes in its sub-group have been identified, the participating processes aggregate the small messages, at an aggregation step 53. Any suitable aggregation protocol can be used at this step. Typically, the aggregation is carried out by a multi-step algorithm, and at each step (except the first), the part of the data received in previous steps is forwarded as needed. One efficient aggregation algorithm for this purpose, with radix k>1, is described below. The aggregation may be carried out over the entire group of processes participating in the application. When the group is large, however, the aggregation protocol is carried out separately within each of the sub-groups defined at step 40. In this case, the message buffers within each sub-group are delivered to their destination processes in the course of execution of the aggregation protocol.

Messages for processes outside the sub-group are also aggregated at step 53 by the processes within the sub-group. At the conclusion of the aggregation algorithm, one of the processes in the sub-group transmits the appropriate aggregated messages to each of the processes outside the sub-group, at an aggregated transmission step 54. Typically, different members of the sub-group are assigned to transmit the aggregated messages to different, respective processes or sets of processes outside the sub-group. In some embodiments, the aggregation protocol is designed such that each of the members of the sub-group aggregates messages for the specific destination processes to which it is assigned to transmit the aggregated messages.

### Aggregation Algorithms

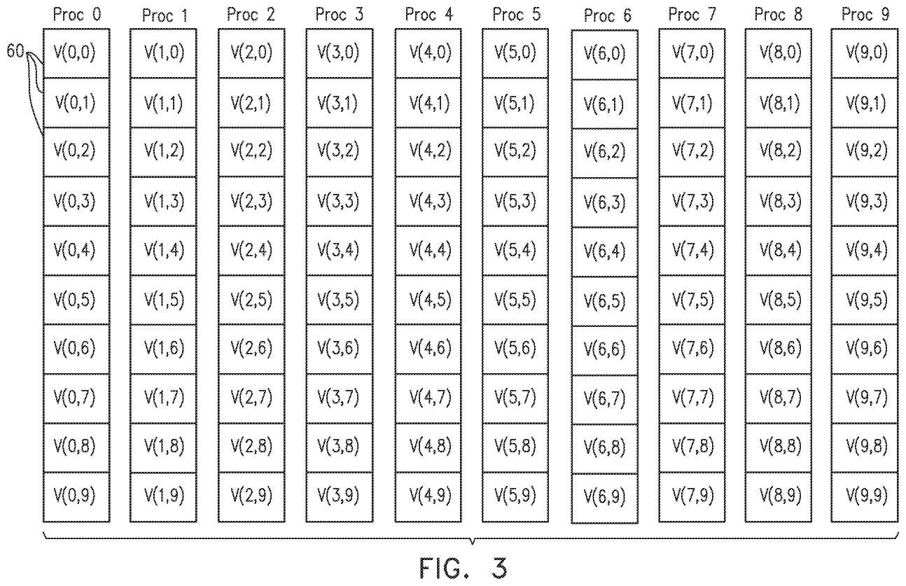

FIGS. 3-9 are block diagrams that schematically illustrate data buffers 60 exchanged among processes in an aggregated collective communication operation, in accordance with an embodiment of the invention. These figures show stages of a multi-step aggregation procedure, with radix k=3, which can be used in implementing aggregation step 53 (FIG. 2). Alternatively, larger radix values may be used.

The algorithm is designed so that for a group size N and radix k>2, all the processes in the group will receive the data messages destined to them within a number of steps S=ceil(logₖ N). The radix defines the number of peer ranks (i.e., the number of other processes) to which each given rank r transmits data at each step of the algorithm. In some of the steps in the algorithm, each given process receives one or more data messages that are destined to itself, along with additional data messages destined to other destination processes. In a subsequent step, the given process forwards the additional data messages that it received in the previous step for other destination processes so that they eventually reach the appropriate destination process.

Formally, the algorithm can be defined as follows: At each step s, for s=0, . . . , S−1:

Sending rank: r.

Number of peers to which each rank r passes buffers at each step: k−1 (as long as peers are no more than N−1 ranks away, i.e., beyond the size of the group).

Peer ranks to which each rank r passes buffers at each step i: Peer=(r+i*k^{s}) % N, i=1, 2, . . . , k−1. (The symbol “%” denotes the modulus operation.)

Data sent: all data held by rank r that is destined for ranks (peer+i*k^{(s+1)} \), i=0, 1, 2, . . . , N−1, without going beyond the size of the group, i.e., when i*k^{(s+1)}≥N, the loop is terminated.

Data sent to a given destination rank at a given step s includes input from the local process itself (as provided in the all-to-all-v call), as well as data that was received by the local process from other processes in previous steps and is now forwarded by the local process in accordance with the aggregation algorithm. In other words, the data sent include input data destined to the appropriate final destinations in the given algorithm step and data received in previous steps for the same destinations. The process transferring the aggregated data adds a header (not shown) specifying the lengths of the different data segments within the aggregation. The specific formulas given above for selection of the peers to which each rank is to send data at each step are presented by way of example. There are many other data transfer patterns that can alternatively be used for this purpose (in fact, N! patterns, related to one another by cyclic permutations, in a group of size N).

FIG. 3 shows data buffers 60 populated by each of a group of ten processes (N=10), labeled Proc 0 through Proc 9, in preparation for an all-to-all-v data exchange. Each column contains the buffers prepared by a given source process J for each destination process K=0, 1, . . . , N−1. The buffers are labeled respectively V(J,K).

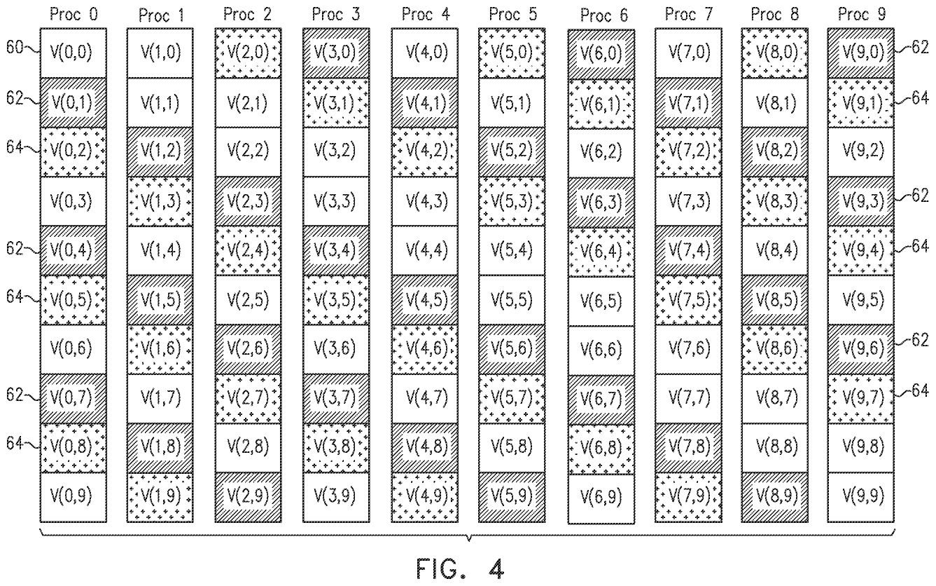

FIG. 4 shows the buffers that are transferred in the first step of the aggregation algorithm, in accordance with the algorithm defined above. Each process, with rank r, sends buffers 62 to the peer process with rank (r+1)% N and sends buffers 64 to the peer process with rank (r+2)% N.

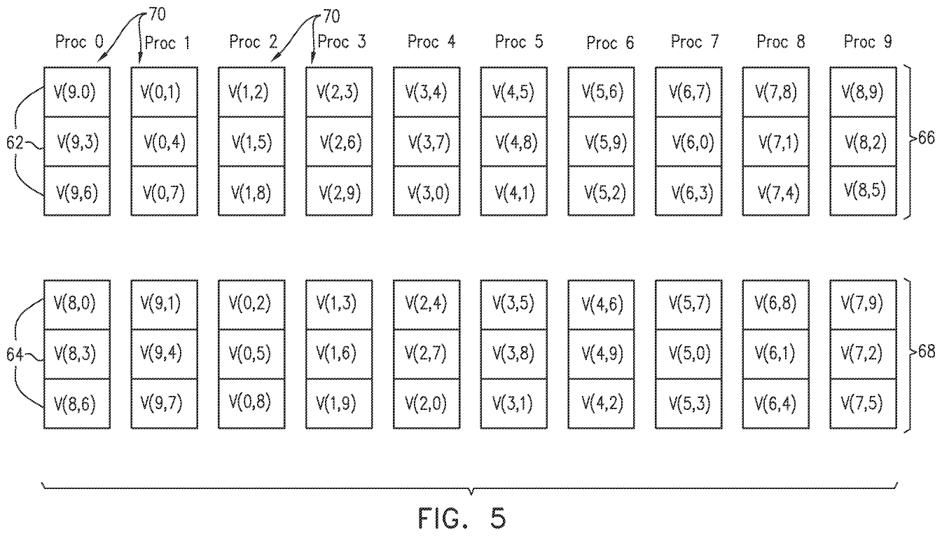

FIG. 5 shows respective receive buffers 70 held by the processes in the group following the first step of the aggregation algorithm. Each process r has received and stored buffers 66 from the column immediately preceding it, with rank (r−1+N) % N, and buffers 68 from the previous column with rank (r−2+N) % N.

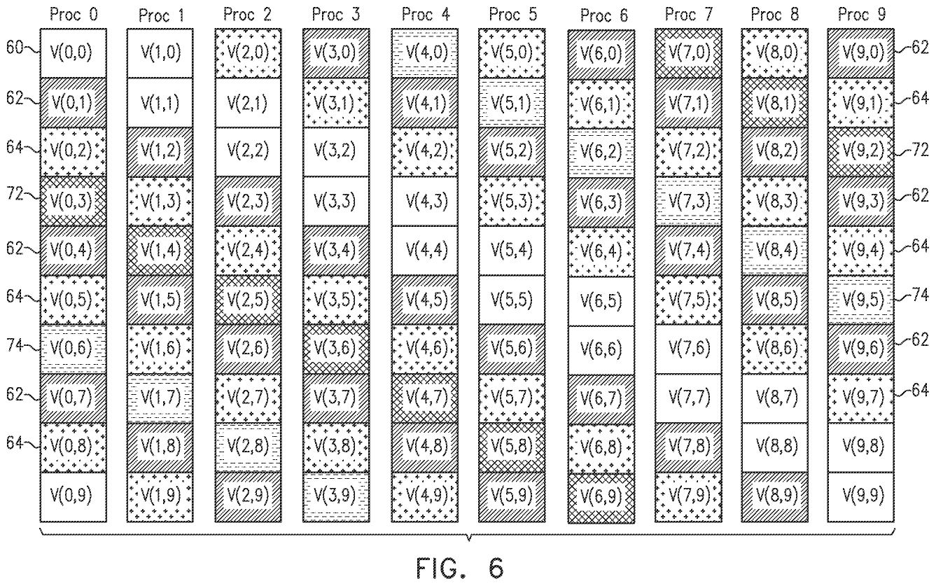

FIG. 6 shows the additional buffers that are transferred at the second step of the aggregation algorithm. Each process, with rank r, transmits a buffer 72 to the peer process with rank (r+3)% N, in a single transmission together with buffers 66 and 68 that were received in the previous step and are destined to rank (r+3)% N. Each process also sends a buffer 74 to the peer process with rank (r+2*3)% N, along with buffers 66 and 68 that were received in the previous step and are destined to rank (r+2*3)% N.

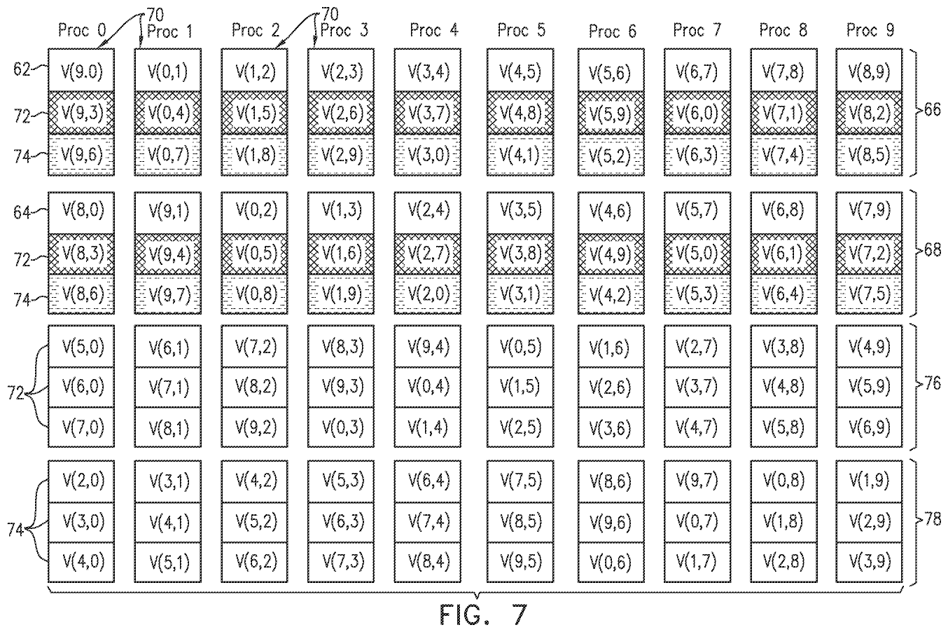

FIG. 7 shows respective receive buffers 70 held by the processes in the group following the second step of the aggregation algorithm. Now, in addition to buffers 66 and 68 received in the first step, each process r has received and stored buffers 76 from the column with rank (r−3+N) % N and buffers 78 from the column with rank (r−6+N) % N. Buffers 72 and 74 are marked within buffers 66 and 68 to indicate that they were transferred to buffers 76 and 78 of the destination ranks in the second step of the algorithm.

Finally, FIG. 8 shows the remaining buffers that are transferred at the third step of the aggregation algorithm. Each process, with rank r, sends a buffer 80 to the peer process with rank (r+9)% N.

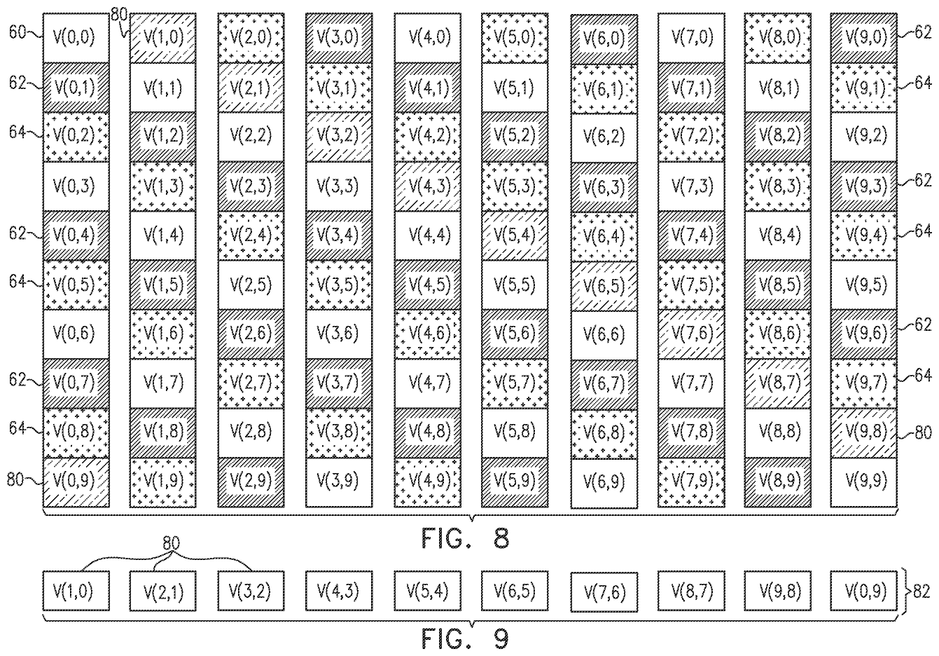

FIG. 9 shows the remaining buffers 82 that are added to the receive buffers held by the processed in the group following the third step of the aggregation algorithm, in addition to the receive buffers that are shown in FIG. 7. Over the course of three steps of message aggregation and transmission, each process J has now received all the data buffers (K,J), K=0, 1, . . . , N−1, that were destined to process J at the beginning of the algorithm.

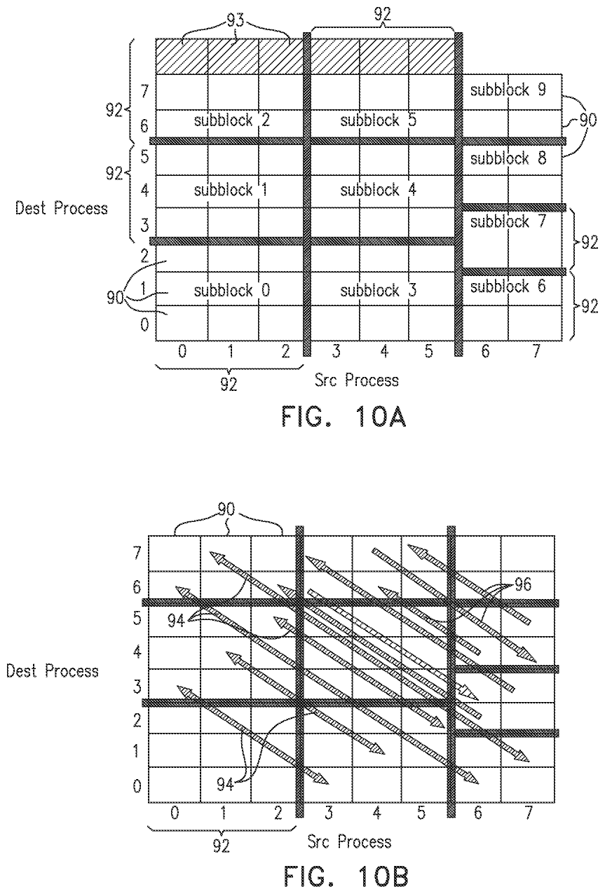

FIGS. 10A and 10B are block diagrams that schematically illustrate a method for partitioning and message aggregation among a group of processes carrying out a collective communication operation, in accordance with an embodiment of the invention. These figures show a method of dividing the group of processes into sub-groups, and then efficiently aggregating the data messages within each sub-group. The method can be applied, for example, in grouping step 40 (FIG. 2) to reduce the sizes of the groups of processes over which small messages are aggregated and mitigate the bandwidth burden that is incurred by the many steps required to aggregate over a large group.

As in the preceding embodiment, FIGS. 10A/B show data buffers 90 that are destined for transmission within a group of eight processes. Each column contains the buffers for transmission from a given source process to each of the processes in the group, which are identified as destination (Dest) processes. The source processes are partitioned into three sub-groups 92. Within the sub-groups, data buffers 90 are grouped into square sub-blocks 93 according to destinations of the data buffers. The processes in each sub-group 92 run a message aggregation algorithm, such as the algorithm shown in FIGS. 3-9, over each of sub-blocks 93, to aggregate data destined for each of the processes in the sub-group. The aggregation algorithm can run in parallel over all the sub-blocks within each sub-group, meaning, for example, that processes 0, 1 and 2 perform the steps of the aggregation simultaneously within sub-blocks 0, 1 and 2.

After the aggregation algorithm has run, the data messages within the diagonal sub-blocks 93 (sub-blocks 0, 4, and 9) will have arrived at the appropriate destination processes within the same sub-group 92. The remaining aggregated data messages, within the other sub-blocks, are transmitted from the sub-group within which they have been aggregated to the appropriate destination processes. As shown in FIG. 10B, these inter-sub-group transfers may be bidirectional, as indicated by arrows 94, or unidirectional, as indicated by arrows 96.

The methods illustrated in the preceding figures assume a static partitioning of sub-groups and sub-blocks. Alternatively, the present methods of aggregation may be applied, mutatis mutandis, to sub-groups that are defined ad hoc, for example based on order of arrival of the messages.

The embodiments described above are cited by way of example, and the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for collective communications, comprising:
invoking a collective operation over a group of computing processes in which the processes in the group concurrently transmit and receive data messages to and from other processes in the group via a communication medium;
detecting by the processes respective sizes of the data messages;
transmitting the data messages for which the respective sizes are greater than a predefined threshold to respective destination processes in the group without aggregation; and
aggregating the data messages for which the respective sizes are less than the predefined threshold and transmitting the aggregated data messages to the respective destination processes.

2. The method according to claim 1, wherein aggregating the data messages comprises dividing the group into sub-groups, and aggregating the data messages within each sub-group.

3. The method according to claim 2, wherein dividing the group into sub-groups comprises defining a static division of the group into the sub-groups.

4. The method according to claim 2, wherein dividing the group into sub-groups comprises defining the sub-groups in response to an order of arrival of the data messages from the processes in the group.

5. The method according to claim 2, wherein aggregating the data messages comprises dividing each sub-group into sub-blocks according to the respective destination processes to which the data messages are destined, and aggregating the sub-blocks within each sub-group.

6. The method according to claim 1, wherein aggregating the data messages comprises performing a multi-step aggregation procedure, with radix k>2, such that in at least a first step, any given process receives at least a first data buffer destined to the given process and a second data buffer destined to a destination process different from the given process, and in at least a second step, subsequent to the first step, the given process forwards the second data buffer to the destination process.

7. The method according to claim 6, wherein in the second step, the given process aggregates data from a local buffer of the given process that is destined to the destination process together with the second data buffer, and transmits the aggregated data in a single transmission to the destination process.

8. The method according to claim 6, wherein in at least the first step, the given process transmits at least first and second local buffers respectively to first and second processes within the group, and in at least the second step, the given process transmits at least third and fourth local buffers respectively to third and fourth processes within the group, which are different from the first and second processes.

9. The method according to claim 1, wherein invoking the collective operation comprises initiating an all-to-all-v, all-to-all-w, all-gather-v, gather-v, or scatter-v operation.

10. A system for collective communications, comprising multiple processors, which are interconnected by a communication medium and are programmed to run respective computing processes such that upon receiving an invocation of a collective operation over a group of the processes in which the processes are to concurrently transmit and receive data messages to and from other processes in the group via the communication medium, the processes detect respective sizes of the data messages, transmit the data messages for which the respective sizes are greater than a predefined threshold to respective destination processes in the group without aggregation, and aggregate the data messages for which the respective sizes are less than the predefined threshold and transmit the aggregated data messages to the respective destination processes.

11. The system according to claim 10, wherein the group is divided into sub-groups, and the data messages are aggregated within each sub-group.

12. The system according to claim 11, wherein the group is divided into the sub-groups according to a static division of the group.

13. The system according to claim 11, wherein the sub-groups are defined in response to an order of arrival of the data messages from the processes in the group.

14. The system according to claim 11, wherein the processes are to divide each sub-group into sub-blocks according to the respective destination processes to which the data messages are destined, and to aggregate the sub-blocks within each sub-group.

15. The system according to claim 10, wherein the processes are to perform a multi-step aggregation procedure, with radix k>2, such that in at least a first step, any given process receives at least a first data buffer destined to the given process and a second data buffer destined to a destination process different from the given process, and in at least a second step, subsequent to the first step, the given process forwards the second data buffer to the destination process.

16. The system according to claim 15, wherein in the second step, the given process is to aggregate data from a local buffer of the given process that is destined to the destination process together with the second data buffer, and to transmit the aggregated data in a single transmission to the destination process.

17. The system according to claim 15, wherein in at least the first step, the given process is to transmit at least first and second local buffers respectively to first and second processes within the group, and in at least the second step, the given process is to transmit at least third and fourth local buffers respectively to third and fourth processes within the group, which are different from the first and second processes.

18. The system according to claim 10, wherein the collective operation comprises an all-to-all-v, all-to-all-w, all-gather-v, gather-v, or scatter-v operation.

19. A computer software product for collective communications among a group of computing processes running on processors, which are interconnected by a communication medium, the product comprising a tangible, non-transitory computer-readable medium in which program instructions are stored, which instructions cause the processors, upon receiving an invocation of a collective operation over a group of the processes in which the processes are to concurrently transmit and receive data messages to and from other processes in the group via the communication medium, to detect respective sizes of the data messages, to transmit the data messages for which the respective sizes are greater than a predefined threshold to respective destination processes in the group without aggregation, and to aggregate the data messages for which the respective sizes are less than the predefined threshold and transmit the aggregated data messages to the respective destination processes.

20. The product according to claim 19, wherein the group is divided into sub-groups, and the instructions cause the processors to aggregate the data messages within each sub-group.

21. The product according to claim 20, wherein the group is divided into the sub-groups according to a static division of the group.

22. The product according to claim 20, wherein the instructions cause the processors to define the sub-groups in response to an order of arrival of the data messages from the processes in the group.

23. The product according to claim 20, wherein the instructions cause the processors to divide each sub-group into sub-blocks according to the respective destination processes to which the data messages are destined, and to aggregate the sub-blocks within each sub-group.

24. The product according to claim 19, wherein the instructions cause the processes to perform a multi-step aggregation procedure, with radix k>2, such that in at least a first step, any given process receives at least a first data buffer destined to the given process and a second data buffer destined to a destination process different from the given process, and in at least a second step, subsequent to the first step, the given process forwards the second data buffer to the destination process.

25. The product according to claim 24, wherein in the second step, the instructions cause the given process to aggregate data from a local buffer of the given process that is destined to the destination process together with the second data buffer, and to transmit the aggregated data in a single transmission to the destination process.

26. The product according to claim 24, wherein in at least the first step, the instructions cause the given process to transmit at least first and second local buffers respectively to first and second processes within the group, and in at least the second step, to transmit at least third and fourth local buffers respectively to third and fourth processes within the group, which are different from the first and second processes.

27. The product according to claim 19, wherein the collective operation comprises an all-to-all-v, all-to-all-w, all-gather-v, gather-v, or scatter-v operation.
